(19) United States
(12) Patent Application Publication
(10) Pub. No.: US 2022/0372208 A1
(43) Pub. Date: Nov. 24, 2022

(54) THERMOSETTING RESIN COMPOSITION, RESIN SHEET, AND METAL BASE SUBSTRATE

(71) Applicant: SUMITOMO BAKELITE CO., LTD., Shinagawa-ku, Tokyo (JP)

(72) Inventors: Tomomasa Kashino, Tokyo (JP); Yoshiki Nishikawa, Tokyo (JP); Tadasuke Endo, Tokyo (JP)

(21) Appl. No.: 17/619,265

(22) PCT Filed: Jun. 17, 2020
(86) PCT No.: PCT/JP2020/023728

§ 371 Date: Dec. 15, 2021

(30) Foreign Application Priority Data
Jun. 21, 2019 (JP) 2019-115337

(51) Int. Cl. C08G 59/24; C08G 59/50; C08K 3/38; B32B 15/092

(52) U.S. Cl. CPC C08G 59/245; C08G 59/5073; C08K 3/38; B32B 15/092; B32B 2457/08; B32B 2250/40; B32B 2250/03; C08K 2201/001; C08K 2003/385

(57) ABSTRACT

Provided is a thermosetting resin composition including an epoxy resin and thermally conductive particles. A thermal conductivity λ₂₀₀ at 200° C. of a cured product obtained by heating the thermosetting resin composition at 200° C. for 90 minutes is 12 W/(m·K) or higher. In addition, a volume resistivity R₂₀₀ of the cured product at 200° C. is preferably 1.0×10¹⁰ Ω·m or more. In addition, a resin sheet using this thermosetting resin composition is provided. Furthermore, a metal base substrate using this thermosetting resin composition is provided.

### TECHNICAL FIELD

The present invention relates to a thermosetting resin composition, a resin sheet, and a metal base substrate. More specifically, the present invention relates to a thermosetting resin composition, as well as a resin sheet and a metal base substrate, which are provided with the thermosetting resin composition or a cured product thereof.

### BACKGROUND ART

There are cases in which there is a demand for heat dissipation in resin materials forming electrical and electronic equipment and the like. In order to meet this demand, studies are being carried out into the use of thermosetting resin compositions to form heat-dissipating members.

As an example, Patent Document 1 describes a thermosetting resin composition in which a thermally conductive filler is dispersed in a thermosetting resin matrix. In this thermosetting resin composition, the filler is a secondary aggregate in which primary particles, which are crystals of boron nitride, are aggregated. In addition, the main constituent materials of the resin matrix are an epoxy resin and a phenolic curing agent and the epoxy resin includes a naphthalene epoxy resin and a bisphenol A type epoxy resin. The glass transition temperature of the cured product of this thermosetting resin composition is 170° C. or higher and the viscosity of this thermosetting resin composition at 100° C. before curing is 20 Pa-s or less.

As another example, Patent Document 2 describes, for purposes of high thermal conductivity and the like, the manufacturing of a multilayer resin sheet by a resin layer forming step in which a resin composition including an epoxy resin having a mesogen skeleton, a curing agent, and an inorganic filler is formed in a sheet form to obtain a resin layer, and an adhesive layer forming step in which an insulating adhesive layer is provided on at least one surface of the resin layer. In addition, it is also described that light or heat is applied to the multilayer resin sheet to cure the resin layer.

### RELATED DOCUMENT

### Patent Document

[Patent Document 1] Japanese Patent No. 6000749

[Patent Document 2] Japanese Unexamined Patent Application Publication No. 2014-139021

### SUMMARY OF THE INVENTION

### Technical Problem

As described above, attempts to form a heat-dissipating member using a thermosetting resin composition including epoxy resin or the like are known.

However, according to the findings of the present inventors, there is still room for improvement in the heat-dissipating members of the related art. For example, there is still room for improvement in terms of heat dissipation, insulation properties, and the like in a case of forming heat-dissipating members in power modules using the thermosetting resin compositions for forming heat-dissipating members of the related art. In particular, this is a problem for power modules for which there is a demand for high reliability.

The present invention was made in consideration of these circumstances. One of the objects of the present invention is to provide a thermosetting resin composition which is preferable for forming a heat-dissipating member in a power module.

### Solution to Problem

As a result of intensive research, the present inventors completed the invention provided below and solved the problem described above.

According to the present invention, there is provided a thermosetting resin composition including an epoxy resin, and thermally conductive particles, in which a thermal conductivity λ₂₀₀ at 200° C. of a cured product obtained by heating the thermosetting resin composition at 200° C. for 90 minutes is 12 W/(m·K) or higher.

In addition, according to the present invention, there is provided a resin sheet including a carrier base material, and a resin layer, which is formed of the thermosetting resin composition described above, provided on the carrier base material.

According to the present invention, there is also provided a metal base substrate including a metal substrate, an insulating layer provided on the metal substrate, and a metal layer provided on the insulating layer, in which the insulating layer is formed of a resin layer formed of the thermosetting resin composition described above, or a cured product of the thermosetting resin composition described above.

### Advantageous Effects of Invention

According to the present invention, there is provided a thermosetting resin composition which is preferable for forming a heat-dissipating member in a power module.

### BRIEF DESCRIPTION OF THE DRAWINGS

FIG. 1 is a cross-sectional view showing a configuration of a metal base substrate of the present embodiment.

### DESCRIPTION OF EMBODIMENTS

A detailed description will be given below of embodiments of the present invention with reference to the drawings.

In the drawings, the same reference numerals are applied to the same components and explanations thereof are not repeated, as appropriate.

To avoid complications, in a case where there are a plurality of identical components in the same drawing, a reference numeral may only be applied to one thereof and reference numerals may not be applied to all.

The drawings are for illustration only. The shapes, dimensional ratios, and the like of each member in the drawings do not necessarily correspond to those of the actual article.

In the present specification, the notation “X to Y” in the description of numerical ranges indicates X or more and Y or less, unless otherwise specified. For example, “1% by mass to 5% by mass” means “1% by mass or more and 5% by mass or less”.

In the notation of groups (atomic groups) in the present specification, notations that do not state substituted or unsubstituted encompass both those groups without substituents and those groups with substituents. For example, the term “alkyl group” encompasses not only alkyl groups which do not have substituents (unsubstituted alkyl groups), but also alkyl groups having substituents (substituted alkyl groups).

The term “organic group” in the present specification means an atomic group from which one or more hydrogen atoms are removed from an organic compound, unless otherwise specified. For example, a “monovalent organic group” represents an atomic group from which one hydrogen atom is removed from any organic compound.

<Thermosetting Resin Composition>

The thermosetting resin composition of the present embodiment includes an epoxy resin and thermally conductive particles.

The thermal conductivity λ₂₀₀ at 200° C. of the cured product obtained by heating the thermosetting resin composition of the present embodiment at 200° C. for 90 minutes is 12 W/(m·K) or higher.

In addition, preferably, the volume resistivity R₂₀₀ at 200° C. of the cured product obtained under the above heating conditions is 1.0×10¹⁰ Ω·m or higher.

The present inventors carried out research from various viewpoints on the reasons why there was still room for improvement in the heat dissipation and insulation properties of the heat-dissipating members of the related art, in particular, in the field of power modules.

As a result of the research, power modules for generators may, for example, be installed near turbines and this fact was considered to have a relationship with the heat dissipation and insulation properties. Specifically, it was considered that, in a case where a power module is installed near a turbine, the temperature around the power module is relatively high, which may cause difficulty in fully dissipating heat from the heat-dissipating members and degradation of the insulation properties.

Proceeding with the research based on this consideration, the present inventors found that the thermal conductivity and the like of the heat-dissipating member in an ambient high-temperature environment, rather than in a room temperature environment which is the normal evaluation environment, have a close relationship with the performance of the power modules for generators.

Based on the above findings, the present inventors set the thermal conductivity A₂₀₀ at 200° C. of the cured product obtained by heating the thermosetting resin composition at 200° C. for 90 minutes as one of the indices for designing the thermosetting resin composition.

Preparing a thermosetting resin composition with λ200 of 12 W/(m·K) or higher (and forming the resin member in the power module using the thermosetting resin composition) successfully improved the heat dissipation and insulation properties of the power module installed in an environment with relatively high temperature, in a novel manner.

λ₂₀₀ is preferably 12 to 25 W/(m·K), and more preferably 13 to 23 W/(m·K).

In addition, the present inventors also focused on the volume resistivity R₂₀₀ at 200° C. of a cured product obtained by heating the thermosetting resin composition at 200° C. for 90 minutes. In the present embodiment, R₂₀₀ is preferably 1.0×10¹⁰ Ω·m or higher. Due to this, it is easy to reduce leakage current and to obtain an effect of suppressing leakage of electricity, short circuits, and the like, during high temperature operation of the power module. R₂₀₀ is preferably 1.0×10¹⁰ to 1.0×10¹⁴ Ω·m, more preferably 3.0×10¹⁰ to 7.0×10¹³ Ω·m, and even more preferably 5.0×10¹⁰ to 5.0×10¹³ Ω·m.

Also, in a case where metal particles are used as the thermally conductive particles, it is possible to easily design λ₂₀₀ to be 12 W/(m·K) or higher. However, in such a case, it is not easy to design R₂₀₀ to be 1.0×10¹⁰ Ω·m or higher due to the conductivity of the metal particles. In this regard, it is also possible to say that the fact that R₂₀₀ is 1.0×10¹⁰ Ω·m or higher expresses, by means of numerical values, that a suitable application of the thermosetting resin composition of the present embodiment is as an “insulating material” and that metal particles that are undesirable from the viewpoint of the insulation properties are not to be included.

In the present embodiment, it is possible to manufacture a thermosetting resin composition in which λ200 and R₂₀₀ are the above values by using appropriate materials such as epoxy resin and by appropriately adjusting the amount of each material or the like. A description will be given below of specific materials, usage amounts thereof, and the like as appropriate.

A more detailed description will be given below of the constituent components, properties, physical characteristics, and the like of the thermosetting resin composition of the present embodiment.

(Epoxy Resin)

The thermosetting resin composition of the present embodiment includes an epoxy resin. The thermosetting resin composition of the present embodiment is a composition which is cured by heat, due to the inclusion of the epoxy resin or the like.

Examples of the epoxy resin include any known epoxy resin without limitation. Examples thereof include glycidyl ethers such as bisphenol A type, F type, S type, and AD type, hydrogenated bisphenol A type glycidyl ethers, phenol novolac type glycidyl ethers, cresol novolac type glycidyl ethers, bisphenol A type novolac type glycidyl ethers, naphthalene type glycidyl ethers, biphenol type glycidyl ethers, dihydroxypentadiene type glycidyl ethers, triphenylmethane type epoxy resins, phenol novolac type epoxy resins, cresol novolac type epoxy resins, and the like.

The epoxy resin preferably includes a mesogen skeleton. Due to this, it is possible to further improve the thermal conductivity (heat dissipation) during curing.

It is considered that a higher-order structure (liquid crystal phase or crystalline phase) is formed by the mesogen skeleton when the epoxy resin including the mesogen skeleton is cured. It is considered that the thermal conductivity (heat dissipation) is further improved by the transmission of heat through the higher-order structure.

Also, it is possible to examine the presence of the higher-order structure in the cured product by observation using a polarized light microscope.

Examples of the mesogen skeleton may include any skeleton which facilitates the expression of liquid crystallinity and crystallinity through the action of intermolecular interactions. The mesogen skeleton preferably includes a conjugated structure. Specific examples of mesogen skeletons include biphenyl skeletons, phenylbenzoate skeletons, azobenzene skeletons, stilbene skeletons, naphthalene skeletons, anthracene skeletons, phenanthrene skeletons, and the like.

The epoxy resin particularly preferably includes a condensed polycyclic aromatic hydrocarbon skeleton, and especially preferably includes a naphthalene skeleton.

For example, with a biphenyl skeleton (—C₆H₄—C₆H₄—), there is a possibility that, at high temperatures, thermal motion may “rotate” the carbon-carbon single bond portion at the center of the left-hand structure and decrease the liquid crystallinity. Similarly, with a phenylbenzoate skeleton (—C₆H₄—COO—C₆H₄—), there is a possibility that the ester bond may rotate at high temperatures. However, for condensed polycyclic aromatic hydrocarbon skeletons such as a naphthalene skeleton, in principle, there is no decrease in liquid crystallinity due to such rotation. In other words, including a condensed polycyclic aromatic hydrocarbon skeleton in the epoxy resin makes it easier to design λ₂₀₀ to be 12 W/(m·K) or higher and thus to further improve the heat dissipation in high temperature environments.

In addition, using a naphthalene skeleton in particular as a polycyclic aromatic hydrocarbon skeleton also makes it possible to suppress the epoxy resin from becoming excessively rigid while obtaining the above advantages. This is because the naphthalene skeleton is comparatively small as a mesogen skeleton. The fact that the epoxy resin is not excessively rigid is preferable in terms of the suppression of cracks and the like due to easy alleviation of stress during the curing of the thermosetting resin composition of the present embodiment.

The epoxy resin preferably includes a bifunctional or higher epoxy resin. In other words, two or more epoxy groups are preferably included in one molecule of the epoxy resin. The number of functional groups of the epoxy resin is preferably 2 to 6, and more preferably 2 to 4.

Preferable epoxy resins are, for example, one or two or more of the following.

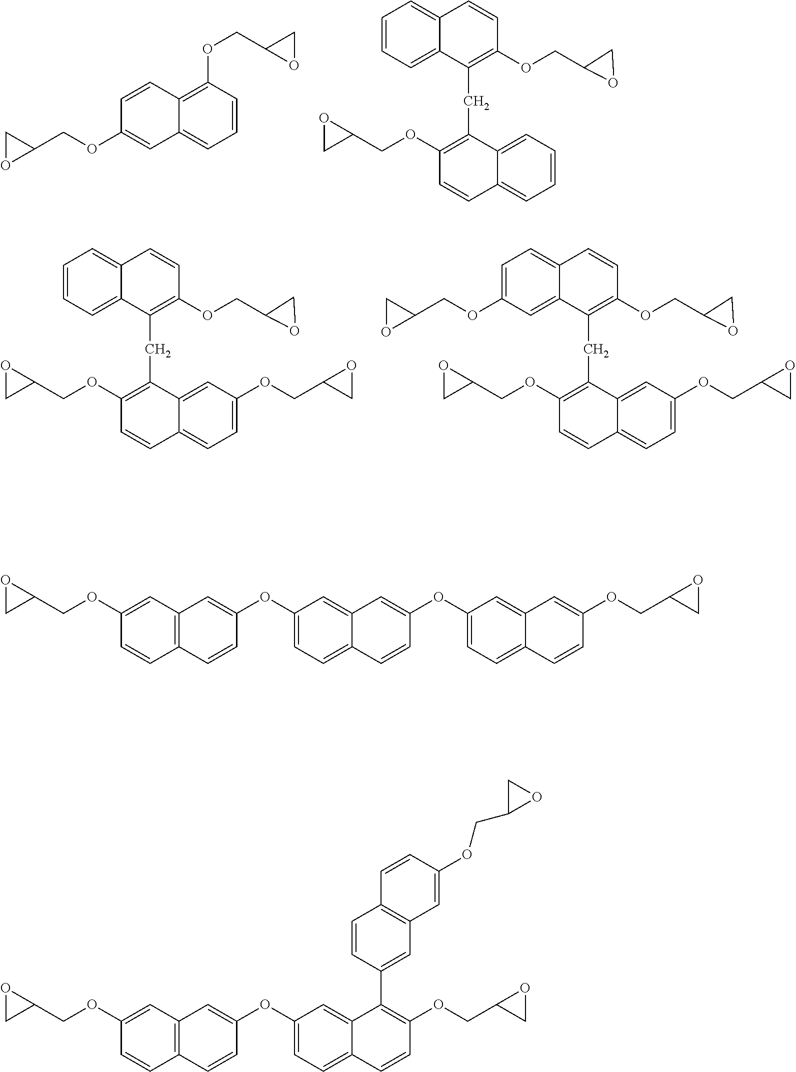 [SMILES: c1cc(OCC2CO2)c2ccc(OCC3CO3)cc2c1 ; c1ccc2c(Cc3c(OCC4CO4)ccc4ccccc34)c(OCC3CO3)ccc2c1 ; c1ccc2c(Cc3c(OCC4CO4)ccc4ccc(OCC5CO5)cc34)c(OCC3CO3)ccc2c1 ; c1cc2ccc(OCC3CO3)c(Cc3c(OCC4CO4)ccc4ccc(OCC5CO5)cc34)c2cc1OCC1CO1 ; c1cc2ccc(Oc3ccc4ccc(Oc5ccc6ccc(OCC7CO7)cc6c5)cc4c3)cc2cc1OCC1CO1 ; c1cc2ccc(Oc3ccc4ccc(OCC5CO5)c(-c5ccc6ccc(OCC7CO7)cc6c5)c4c3)cc2cc1OCC1CO1]

The epoxy equivalent of the epoxy resin is, for example, 100 to 200 g/eq, preferably 105 to 190 g/eq, more preferably 110 to 180 g/eq. Using an epoxy resin having an appropriate epoxy equivalent makes it possible to control the curability, optimize the physical characteristics of the cured product, and the like.

As one aspect, the epoxy resin preferably includes a liquid epoxy resin which is liquid at room temperature (23° C.). Specifically, a part or all of the epoxy resin is preferably in liquid form at 23° C.

The use of a liquid epoxy resin is preferable in terms of ease of forming a cured product with a desired shape and the like.

The thermosetting resin composition of the present embodiment may include only one epoxy resin or may include two or more epoxy resins.

The lower limit value of the content of the epoxy resin is, for example, 5% by mass or more, preferably 7% by mass or more, and more preferably 10% by mass or more in the entire non-volatile components other than the thermally conductive particles. Due to this, it is possible to ensure sufficient curability.

The upper limit value of the epoxy resin content is, for example, 40% by mass or less, preferably 35% by mass or less, an dmore preferably 30% by mass or less in the entire non-volatile component other than the thermally conductive particles. The content of the epoxy resin not being excessive makes it possible to sufficiently include the other components and makes it easy to design a composition in which λ₂₀₀ is 12 W/(m·K) or higher and/or R₂₀₀ is 1.0×10¹⁰ Ω·m or higher. It is easy to further improve the heat dissipation and insulation properties.

For confirmation, “non-volatile components” are those components which do not volatilize and remain when the thermosetting resin composition is heated and cured. Usually, non-volatile components refer to components other than volatile solvents.

(Thermally Conductive Particles)

The thermosetting resin composition of the present embodiment includes thermally conductive particles. The presence of the thermally conductive particles makes it easy to obtain sufficient heat dissipation.

The thermally conductive particles include one or more selected from the group consisting of silica, alumina, aluminum nitride, boron nitride, silicon nitride, silicon carbide, and magnesium oxide. Two or more different thermally conductive particles may be used in combination, from the viewpoint of balancing thermal conductivity, insulation properties, and the like.

As the thermally conductive particles, boron nitride is particularly preferable in terms of high thermal conductivity.

It is possible for boron nitride to include, for example, monodispersed particles or aggregated particles of boron nitride, or mixtures thereof. The boron nitride may be granulated in the form of granules. Using aggregated particles of boron nitride further improves the thermal conductivity. The aggregated particles may be sintered or non-sintered particles.

The amount of thermally conductive particles is, for example, 100 to 400 parts by mass, preferably 150 to 350 parts by mass, and more preferably 200 to 300 parts by mass, when the entirety of the non-volatile components other than the thermally conductive particles in the composition is 100 parts by mass. Using a sufficiently large amount of thermally conductive particles makes it possible to sufficiently improve the thermal conductivity. Not using the thermally conductive particles excessively makes it possible to make the mechanical properties and the like of the cured product favorable.

(Curing Agent)

The thermosetting resin composition of the present embodiment preferably includes a curing agent.

The curing agent is not particularly limited as long as the curing agent reacts with the epoxy groups in the epoxy resin to cure the composition.

In particular, the findings of the present inventors were that it is easy to design R₂₀₀ to be 1.0×10¹⁰ Ω·m or higher by using, as the curing agent, at least a curing agent which does not produce a hydroxy group by reaction with an epoxy group (this curing agent is also referred to below as “curing agent (a)”). Thus, it is possible to improve the insulation properties.

The details of the reason for this are unknown, but it is considered that the formation of highly polar hydroxy groups is reduced, such that it is difficult for electric current to flow therethrough.

The curing agent (a) may be a low molecular weight compound or may be a resin (polymer or oligomer).

Examples of the curing agent (a) include the following.
Polyarylate compounds, specifically, a compound represented by General Formula (a1)

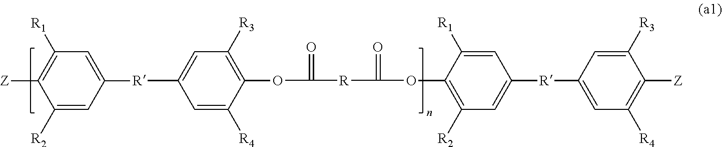

Active ester compounds, for example, a compound represented by General Formula (a2)

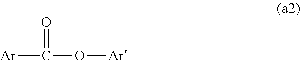

Cyanate ester compounds, for example, a compound represented by General Formula (a3)

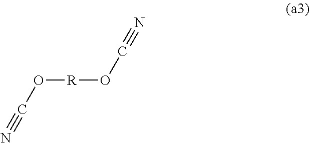

Isocyanate compounds, for example, a compound represented by General Formula (a4)

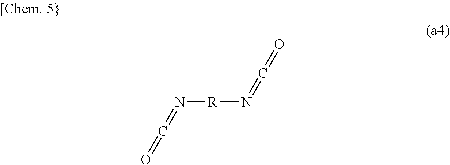

Imidazole compounds

In General Formulas (a1), (a3), and (a4), R and R′ are each independently a divalent linking group.

R and R′ are preferably groups including a conjugated double bond. More specifically, R and R′ are aromatic rings, aromatic condensed rings, or groups represented by General Formula -A¹-X-A²-. In this General Formula, A¹ and A² each independently represent a group selected from aromatic groups, fused aromatic groups, alicyclic groups, and alicyclic heterocyclic groups. In addition, X is a single bond or a divalent linking group.

As A¹ and A², hydrocarbon groups with 6 to 12 carbon atoms including benzene rings, hydrocarbon groups with 10 to 20 carbon atoms including naphthalene rings, hydrocarbon groups with 12 to 24 carbon atoms including biphenyl structures, hydrocarbon groups with 12 to 36 carbon atoms including three or more benzene rings, hydrocarbon groups with 12 to 36 carbon atoms including fused aromatic groups, alicyclic heterocyclic groups with 4 to 36 carbon atoms, and the like are preferable.

Specific examples of A¹ and A² include phenylene, biphenylene, naphthylene, anthracenylene, cyclohexyl, pyridyl, pyrimidyl, thiophenylene, and the like. The above may be unsubstituted or may have substituents such as aliphatic hydrocarbon groups, halogen groups, cyano groups, or nitro groups.

As X, for example, a divalent substituent selected from the group consisting of a single bond, —C═C—, —C≡C—, —CO—O—, —CO—NH—, —CH═N—, —CH═N—N═CH—, —N═N—, and —N(O)═N— is preferable.

In General Formula (a1),

R₁, R₂, R₃ and R₄ are each independently an aliphatic group with 1 to 4 carbon atoms, an aromatic group with 6 to 12 carbon atoms including a benzene ring, and the like, and Z is a hydrogen atom, a hydroxy group, or an alkoxy group, and n is the number of repetitions, typically, 1 to 100.

In General Formula (a2), Ar and Ar′ are each independently an aromatic group (may be a heteroaromatic group), an alicyclic group, and the like.

Specific examples of Ar and Ar′ include phenyl group, biphenyl group, naphthyl group, anthryl group, cyclohexyl group, pyridyl group, pyrimidyl group, thienyl group, and the like.

The aromatic group and alicyclic group of Ar and Ar′ may be unsubstituted or may have substituents. Examples of substituents include aliphatic hydrocarbon groups, halogen groups, cyano groups, nitro groups, and the like.

In a case of using the curing agent (a), only one may be used, or two or more may be used in combination.

In a case where the thermosetting resin composition of the present embodiment includes the curing agent (a), the equivalent ratio of the curing agent (a) with respect to the epoxy resin (number of moles of reactive functional groups in the curing agent (a)/number of moles of epoxy groups in the epoxy resin) in the thermosetting resin composition is preferably 1.0 to 2.0, and more preferably 1.1 to 1.8.

The thermosetting resin composition of the present embodiment may include a curing agent which is not the curing agent (a). Examples of such curing agents include phenol-based curing agents, amine-based curing agents, acid anhydride-based curing agents, mercaptan-based curing agents, and the like. In a case where the above are used, the above may be used alone, or two or more may be used in combination.

In a case of using a curing agent, only one may be used, or two or more may be used in combination.

In a case where the thermosetting resin composition of the present embodiment includes a curing agent, the amount is preferably 20% by mass to 70% by mass of the entirety of the non-volatile components other than the thermally conductive particles in the composition, and more preferably 30% by mass to 60% by mass. By appropriately adjusting the amount of the curing agent, it may be possible to further improve the heat dissipation and insulation properties. In addition, it may also be possible to control the curability and improve the mechanical properties of the cured product, and the like.

(Curing Accelerator)

The thermosetting resin composition of the present embodiment may include a curing accelerator. Due to this, it is possible to accelerate the curing reaction.

The type and blending amount of the curing accelerator are not particularly limited. An appropriate curing accelerator may be selected from the viewpoints of reaction rate, reaction temperature, storability, and the like.

Examples of curing accelerators include imidazoles, organophosphorus compounds, organometallic salts, tertiary amines, phenol compounds, organic acids, and the like. The above may be used alone or in a combination of two or more. Among these, from the viewpoint of heat resistance, it is possible to use at least one selected from the group consisting of organophosphorus compounds, complexes of organophosphorus compounds with organoboron compounds, and compounds having intramolecular polarization created by adding compounds having n-bonds to organophosphorus compounds. Examples of compounds having n-bonds include maleic anhydride, quinone compounds, diazophenylmethane, phenolic resins, and the like. In addition, quaternary phosphonium salt-based compounds, quaternary ammonium salt-based compounds, fatty acid salt-based compounds, metal chelate-based compounds, metal salt-based compounds, and the like may also be used. In addition, latent curing accelerators such as dihydrazide compounds such as dicyandiamides and adipic acid dihydrazides, guanamic acid, melamic acid, addition compounds of epoxy compounds and imidazole compounds, addition compounds of epoxy compounds and dialkylamines, addition compounds of amines and thioureas, and addition compounds of amines and isocyanates may also be used.

Examples of imidazoles include 2-methylimidazole, 2-ethyl-4-methylimidazole, 2-phenyl-4-methylimidazole, 2,4-diethylimidazole, 2-phenyl-4-methyl-5-hydroxyimidazole, 2-phenyl-4,5-dihydroxymethylimidazole, 1-cyanoethyl-2-phenylimidazole, 1-cyanoethyl-2-phenylimidazolium trimellitate, and the like.

Specific examples of organophosphorus compounds include triphenylphosphine, tri-p-tolylphosphine, diphenyl(p-tolyl)phosphine, tris(alkylphenyl)phosphine, tris(alkoxyphenyl)phosphine, tris(alkylalkoxyphenyl)phosphine, tris(dialkylphenyl)phosphine, tris(trialkylphenyl)phosphine, tris(tetraalkylphenyl)phosphine, tris(dialkoxyphenyl)phosphine, tris(trialkoxyphenyl)phosphine, tris(tetraalkoxyphenyl)phosphine, trialkylphosphine, dialkylarylphosphine, alkyl diarylphosphine, 1,2-bis-(diphenylphosphino)ethane, and the like.

As complexes of organophosphine compounds with organoboron compounds, specific examples include triphenylphosphine triphenylborane, tetraphenylphosphonium tetraphenylborate, tetraphenylphosphonium tetra-p-tolylborate, tetrabutylphosphonium tetraphenylborate, tetraphenylphosphonium n-butyltriphenylborate, butyltriphenylphosphonium tetraphenylborate, methyltributylphosphonium tetraphenylborate, and the like.

Examples of organometallic salts include zinc naphthenate, cobalt naphthenate, tin octylate, cobalt octylate, cobalt(II) bisacetylacetonate, cobalt(III) trisacetylacetonate, and the like.

Examples of tertiary amines include triethylamine, tributylamine, 1,4-diazabicyclo[2.2.2]octane, 1,8-diazabicyclo(5,4,0)undecen-7, and the like.

Examples of phenol compounds include phenol, bisphenol A, nonylphenol, 2,2-bis(3-methyl-4-hydroxyphenyl)propane, and the like.

Examples of organic acids include acetic acid, benzoic acid, salicylic acid, p-toluenesulfonic acid, and the like.

Examples of phenol-based curing accelerators include novolac phenolic resins such as phenol novolac resin, cresol novolac resin, naphthol novolac resin, aminotriazine novolac resin, novolac resin, and trisphenylmethane phenol novolac resin; modified phenolic resins such as terpene-modified phenolic resins and dicyclopentadiene-modified phenolic resins; aralkyl resins such as phenolic aralkyl resins having phenylene skeletons and/or biphenylene skeletons and naphthol aralkyl resins having phenylene skeletons and/or biphenylene skeletons; bisphenol compounds such as bisphenol A and bisphenol F; resol-type phenolic resins; allyl phenolic resins, and the like.

In a case where a curing accelerator is used, only one may be used, or two or more may be used in combination.

In a case where a curing accelerator is used, the amount is, for example, 0.1% by mass to 20% by mass of the entirety of the non-volatile components other than the thermally conductive particles, preferably 0.1% by mass to 5% by mass, and more preferably 0.2% by mass to 4.5% by mass.

(Mesogenic Structure-Containing Resin)

The thermosetting resin composition of the present embodiment preferably includes, apart from the epoxy resin, a resin having a mesogenic structure and a weight average molecular weight of 500 or more. Due to this, it is possible to further improve the thermal conductivity (heat dissipation).

In the present specification, this resin is also referred to as a “mesogenic structure-containing resin”.

The mesogenic structure-containing resin preferably includes a phenoxy resin. That is, a mesogenic structure-containing resin preferably includes a mesogenic structure-containing phenoxy resin.

“Phenoxy resins” are polyhydroxy polyethers synthesized from bisphenols and epichlorohydrin in a narrow sense, but in the present specification, phenoxy resins also include polymers obtained by the heavy addition reaction of polyfunctional epoxy resins and polyfunctional phenols (phenoxy resins in a broad sense).

A detailed description will be given below of a case where the mesogenic structure-containing resin is a mesogenic structure-containing phenoxy resin.

One example of a mesogenic structure-containing phenoxy resin is a resin which includes a structural unit derived from a phenol compound and a structural unit derived from an epoxy compound in the molecule and which includes a compound having a mesogenic structure in at least one of these structural units.

Another example of a mesogenic structure-containing phenoxy resin is a resin which includes, in the molecule, a structural unit derived from a mesogenic structure containing phenol compound.

As one example, it is possible to obtain a mesogenic structure-containing phenoxy resin by reacting a polyfunctional phenol compound having two or more hydroxy groups in the molecule with a polyfunctional epoxy compound having two or more epoxy groups in the molecule.

That is, it is possible for the mesogenic structure-containing phenoxy resin to include a reaction compound of a polyfunctional phenol compound and a polyfunctional epoxy compound. Either or both of these polyfunctional phenol compounds and polyfunctional epoxy compounds have a mesogenic structure.

As another example, it is possible to obtain a mesogenic structure-containing phenoxy resin by the addition polymerization reaction of a mesogenic structure-containing phenol compound having two or more phenolic groups in the molecule in epichlorohydrin.

That is, it is possible for the mesogenic structure-containing phenoxy resin to include the addition polymerization product of the mesogenic structure-containing phenol compound.

It is possible to perform the manufacturing of the mesogenic structure-containing phenoxy resin without a solvent or in the presence of a reaction solvent. As a reaction solvent, it is possible to suitably use a non-protic organic solvent, for example, methyl ethyl ketone, dioxane, tetrahydrofuran, acetophenone, N-methylpyrrolidone, dimethyl sulfoxide, N,N-dimethylacetamide, N,N-dimethylformamide, sulfolane, cyclohexanone, and the like. It is possible to obtain a resin dissolved in a suitable solvent by performing solvent substitution or the like after the reaction. In addition, it is also possible to make the phenoxy resin obtained by the solvent reaction into a solid resin which does not include a solvent by a desolvation process using an evaporator or the like.

As reaction catalysts able to be used in the manufacturing of the mesogenic structure-containing phenoxy resin, polymerization catalysts known in the related art, for example, alkali metal hydroxides, tertiary amine compounds, quaternary ammonium compounds, tertiary phosphine compounds, quaternary phosphonium compounds, and the like, are suitably used.

The mesogenic structure has, for example, the structure represented by General Formula (1) or General Formula (2).

-A¹¹-x-A¹²- (1)

-x-A¹¹-x- (2)

In General Formula (1) and General Formula (2), A¹¹ and A¹² each independently represent an aromatic group, a fused aromatic group, an alicyclic group, or an alicyclic heterocyclic group, and x each independently represents a direct bond or a divalent bonding group selected from the group consisting of —O—, —S—, —C═C—, —C═C—, —CO—, —CO—O—, —CO—NH—, —CH═N—, —CH═N—N═CH—, —N═N—, and —N(O)═N—.

Preferably, A¹ and A² are each independently selected from a hydrocarbon group with 6 to 12 carbon atoms with a benzene ring, a hydrocarbon group with 10 to 20 carbon atoms with a naphthalene ring, a hydrocarbon group with 12 to 24 carbon atoms with a biphenyl structure, a hydrocarbon group with 12 to 36 carbon atoms with three or more benzene rings, a hydrocarbon group with 12 to 36 carbon atoms with a fused aromatic group, and an alicyclic heterocyclic group with 4 to 36 carbon atoms. A¹ and A² may be unsubstituted or may be derivatives having substituents.

Examples of A¹ and A² in the mesogenic structure include phenylene, biphenylene, naphthylene, anthracenylene, cyclohexyl, pyridyl, pyrimidyl, thiophenylene, and the like. In addition, the above may be unsubstituted or may be derivatives having substituents such as aliphatic hydrocarbon groups, halogen groups, cyano groups, and nitro groups.

As the x corresponding to the bonding group (linking group) in the mesogenic structure, for example, a direct bond or a divalent substituent selected from the group of —C═C—, —C═C—, —CO—O—, —CO—NH—, —CH═N—, —CH═N—N═CH—, —N═N—, or —N(O)═N— is preferable.

Here, a direct bond means a single bond or that A¹ and A² in the mesogenic structure are linked to each other to form a ring structure. For example, a naphthalene structure may be included in the structure represented by General Formula (1).

In a case where the mesogenic structure-containing phenoxy resin is obtained by the reaction of a polyfunctional phenol compound with a polyfunctional epoxy compound, as the polyfunctional phenol compound, for example, it is possible to use a mesogenic structure-containing compound represented by General Formula (A).

In addition, as a polyfunctional epoxy compound, it is possible to use a mesogenic structure-containing compound represented by General Formula (B).

These compounds may be used alone or in a combination of two or more.

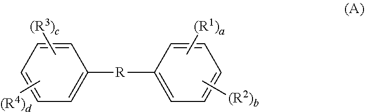

In General Formula (A),

R¹ and R³ each independently represent a hydroxy group,

R² and R⁴ each independently represent one selected from a hydrogen atom, a chain or cyclic alkyl group with 1 to 6 carbon atoms, a phenyl group, and a halogen atom,

a and c are integers of 1 to 3, respectively, and

b and d are integers of 0 to 2, respectively.

However, a+b and c+d are each any one of 1 to 3.

a+c may be 3 or more.

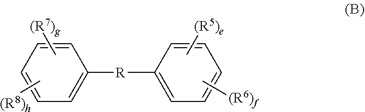

In General Formula (B)

R⁵ and R⁷ each independently represent a glycidyl ether group,

R⁶ and R⁸ each independently represent one selected from a hydrogen atom, a chain or cyclic alkyl group with 1 to 6 carbon atoms, a phenyl group, and a halogen atom,

e and g are each independently integers of 1 to 3, and

f and h are each independently integers of 0 to 2.

However, e+f and g+h are each any one of 1 to 3.

R in General Formula (A) and General Formula (B) represents -A¹¹-x-A¹²-, -x-A¹¹-x-, or -x- as described above, respectively. The two benzene rings in General Formula (A) may be linked to each other to form a condensed ring.

Specific examples of R², R⁴, R⁶, and R⁸ include, respectively, a hydrogen atom, a methyl group, an ethyl group, a propyl group, a butyl group, a chlorine atom, a bromine atom, and the like. Among the above, a hydrogen atom and also a methyl group are particularly preferable.

As the polyfunctional epoxy compound containing a mesogenic structure, for example, addition polymerization products of the compound represented by General Formula (B) may be used. The above may be used alone or in a combination of two or more.

As the polyfunctional phenol compound and the polyfunctional epoxy compound, a polyfunctional phenol compound having three or more hydroxy groups in the molecule and a polyfunctional epoxy compound having two or more epoxy groups in the molecule may be used.

That is, it is possible for the mesogenic structure-containing phenoxy resin to include a branched reaction compound of a polyfunctional phenol compound having three or more hydroxy groups in the molecule and a polyfunctional epoxy compound having two or more epoxy groups in the molecule.

It is possible for the polyfunctional phenol compound having three or more hydroxy groups in the molecule to include, for example, polyphenols or polyphenol derivatives.

A polyphenol is typically a compound which contains three or more phenolic hydroxy groups in one molecule. In addition, the polyphenol is preferably provided with the mesogenic structure described above in the molecule. For example, as the mesogenic structure, it is possible to use a biphenyl skeleton, a phenylbenzoate skeleton, an azobenzene skeleton, a stilbene skeleton, or the like.

Polyphenol derivatives include compounds which are changed to other substituents at substitutable positions in the compound, with respect to polyphenol compounds having three or more phenolic hydroxy groups and a mesogenic structure.

In the present embodiment, it is possible to obtain the branched reaction compound described above by using one or two or more of the polyfunctional phenol compounds described above, including a polyfunctional phenol compound having at least three or more hydroxy groups in the molecule, and one or two or more of the polyfunctional epoxy resins described above.

For example, a combination of a trifunctional phenol compound and a bifunctional epoxy compound or a combination of a trifunctional phenol compound, a bifunctional phenol compound, and a bifunctional epoxy compound may be used.

As a trifunctional phenol compound, for example, it is possible to use resveratrol, represented by the following chemical formula.

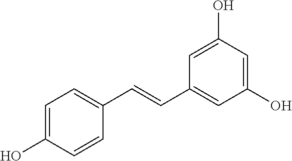 [SMILES: Oc1ccc(/C=C/c2cc(O)cc(O)c2)cc1]

As a bifunctional phenol compound, for example, it is possible to use a compound in which the hydroxy groups of R¹ and R³ described above are bonded to the para-position of the respective benzene ring.

In addition, as a bifunctional epoxy compound, it is possible to use a compound in which the glycidyl ether groups of R⁵ and R⁷ described above are bonded to the para-position of the respective benzene ring.

In addition, in a case where the bifunctional phenol compound is provided with a naphthalene ring as a condensed ring, it is possible to use a bifunctional epoxy compound in which the hydroxy groups of R¹ and R³ are bonded to any one of position 1 and position 4, position 1 and position 5, position 1 and position 6, position 2 and position 3, position 2 and position 6, or position 2 and position 7 of the naphthalene ring. In addition, in a case where the bifunctional epoxy compound described above is provided with a naphthalene ring as a condensed ring, it is possible to use a compound in which the glycidyl ether groups of R⁵ and R⁷ described above are bonded to any one of position 1 and position 4, position 1 and position 5, position 1 and position 6, position 2 and position 3, position 2 and position 6, or position 2 and position 7 of the naphthalene ring.

It is possible to obtain a branched reaction compound (branched phenoxy resin) by combining a trifunctional phenol compound and a bifunctional epoxy compound as described above, or by combining a trifunctional phenol compound, a bifunctional phenol compound, and a bifunctional epoxy compound.

On the other hand, among the polyfunctional phenol compounds and the polyfunctional epoxy compounds described above, bifunctional phenol compounds and bifunctional epoxy compounds may be used. The above may be used alone or in a combination of two or more.

In other words, it is possible for a mesogenic structure-containing phenoxy resin to include a linear reaction compound of a bifunctional phenol compound having two hydroxy groups in the molecule and a bifunctional epoxy compound having two epoxy groups in the molecule.

As the bifunctional phenol compound, it is possible to use a compound in which the hydroxy groups of R¹ and R³ are bonded to the para-position of the respective benzene rings. In addition, as a bifunctional epoxy compound, it is possible to use a compound in which the glycidyl ether groups of R⁵ and R⁷ are bonded to the para-positions of the respective benzene rings.

In a case where the bifunctional phenol compound is provided with a naphthalene ring as a condensed ring, it is possible to use a compound in which the hydroxy groups of R¹ and R³ are bonded to any one of position 1 and position 3, position 1 and position 4, position 1 and position 5, position 1 and position 6, position 2 and position 3, position 2 and position 6, position 2 and position 7, or position 2 and position 8 of the naphthalene ring. From the viewpoint of thermal conductivity and heat resistance of the molecule, bifunctional phenol compounds provided with hydroxy group naphthalene rings at position 1 and position 4, position 1 and position 5, position 1 and position 6, position 2 and position 3, position 2 and position 6, or position 2 and position 7 are more preferably selected. In addition, in a case where the bifunctional epoxy compound is provided with a naphthalene ring as a condensed ring, it is possible to use a compound in which the glycidyl ether groups of R⁵ and R⁷ are bonded to any one of position 1 and position 3, position 1 and position 4, position 1 and position 5, position 1 and position 6, position 2 and position 3, position 2 and position 6, position 2 and position 7, or position 2 and position 8 of the naphthalene ring. From the viewpoint of thermal conductivity and heat resistance of the molecule, epoxy resins provided with naphthalene rings having glycidyl ether groups at position 1 and position 4, position 1 and position 5, position 1 and position 6, position 2 and position 3, position 2 and position 6, or position 2 and position 7 are more preferably selected.

Using such a bifunctional phenol compound and a bifunctional epoxy compound together makes it possible to obtain a linear reaction compound (linear phenoxy resin).

It is possible for branched phenoxy resins and linear phenoxy resins to have epoxy groups or hydroxy groups at the end of the molecule and epoxy groups or hydroxy groups inside the molecule. Having epoxy groups at the end or inside the molecule makes it possible to form cross-linking reactions, thus, it is possible to increase heat resistance.

In addition, having a linear structural unit which is rigid and electron conjugated makes it possible to improve the heat dissipation properties.

The weight average molecular weight (Mw) of the mesogenic structure-containing resin is usually 500 or more, preferably 500 to 200,000, more preferably 1,000 to 100,000, and even more preferably 3,000 to 50,000. Mw is a value measured by gel permeation chromatography and converted using a standard polystyrene calibration curve.

In a case where a mesogenic structure-containing resin is used, only one mesogenic structure-containing resin may be used, or two or more with different structures, molecular weights, and the like may be used together.

In a case where a mesogenic structure-containing resin is used, the amount thereof is, for example, 1% by mass to 70% by mass, preferably 2% by mass to 50% by mass, and more preferably 3% by mass to 45% by mass in the entirety of the non-volatile components other than the thermally conductive particles in the composition.

(Other Components)

It is possible for the thermosetting resin composition of the present embodiment to include optional components other than the above components as long as λ₂₀₀ is 12 W/(m·K) or higher. The thermosetting resin composition of the present embodiment may include no optional components, may include only one optional component, or may include two or more optional components.

Examples of the optional components include a silane coupling agent, an antioxidant, a leveling agent, and the like.

Examples of silane coupling agents include epoxy-based silane coupling agents, amino-based silane coupling agents, mercapto-based silane coupling agents, ureido-based silane coupling agents, cationic-based silane coupling agents, titanate-based coupling agents, silicone oil type coupling agents, and the like.

Among the above, it is preferable to use a silane coupling agent having epoxy groups, amino groups, mercapto groups, ureido groups, or hydroxy groups as functional groups. In addition, from the viewpoint of improving compatibility with resin components, silane coupling agents having non-reactive phenyl groups are also preferable.

Specific examples of silane coupling agents having functional groups include 3-glycidoxypropyltrimethoxysilane, 3-glycidoxypropyltriethoxysilane, 3-glycidoxypropylmethyldiethoxysilane, 3-glycidoxypropylmethyldimethoxysilane, 2-(3,4-epoxycyclohexyl)ethyltrimethoxysilane, 3-aminopropyltriethoxysilane, 3-(2-aminoethyl)aminopropyltrimethoxysilane, 3-(2-aminoethyl)aminopropyltrimethoxysilane, 3-aminopropyltrimethoxysilane, 3-mercaptopropyltrimethoxysilane, 3-mercaptotriethoxysilane, 3-ureidopropyltriethoxysilane, and the like.

Examples of silane coupling agents containing phenyl groups include 3-phenylaminopropyltrimethoxysilane, 3-phenylaminopropyltriethoxysilane, N-methylanilino-propyltrimethoxysilane, N-methylanilino-propyltriethoxysilane, 3-phenyliminopropyltrimethoxysilane, 3-phenyliminopropyltriethoxysilane, phenyltrimethoxysilane, phenyltriethoxysilane, diphenyldimethoxysilane, diphenyldiethoxysilane, triphenylmethoxysilane, triphenylethoxysilane, and the like.

In a case where a silane coupling agent is used, the amount thereof is, for example, 0.05 parts by mass to 3 parts by mass with respect to 100 parts by mass of thermally conductive particles, and preferably 0.1 parts by mass to 2 parts by mass.

(Linear Expansion Coefficient of Cured Product)

Designing the thermosetting resin composition such that the linear expansion coefficient of the cured product becomes an appropriate value makes it possible to further improve the reliability of the power module including the cured product, for example.

Specifically, the linear expansion coefficient α at 23° C. to 40° C. of the cured product obtained by heating the thermosetting resin composition of the present embodiment at 200° C. for 90 minutes is preferably 20 ppm/° C. or lower, more preferably 19 ppm/° C. or lower, and even more preferably 18 ppm/° C. or lower. Basically, the smaller α₁ is, the better, but from a practical design point of view, α₁ is 13 ppm/° C. or higher.

It is possible to find the linear expansion coefficient of the cured product, for example, based on data obtained by thermomechanical analysis (abbreviated as TMA).

(Glass Transition Temperature of Cured Product)

Designing the thermosetting resin composition such that the glass transition temperature of the cured product becomes an appropriate value makes it possible to further improve the reliability of the power module including the cured product, for example. For example, even if the power module is continuously used in a high temperature environment, it is possible to reduce failures and defects of the power module.

Specifically, the glass transition temperature of the cured product obtained by heating the thermosetting resin composition of the present embodiment at 200° C. for 90 minutes is preferably 180° C. or higher, more preferably 190° C. or higher, and even more preferably 200° C. or higher. The upper limit of the glass transition temperature is preferably 350° C. or lower, and more preferably 300° C. or lower, from the viewpoint of ease of design of the thermosetting resin composition.

As the glass transition temperature of the cured product, for example, it is possible to adopt the temperature of the peak top of the loss tangent (tan δ) obtained when dynamic viscoelasticity is measured while the temperature of the cured product is increased.

(Characteristics of Composition)

The characteristics of the thermosetting resin composition of the present embodiment are, for example, being varnish-like (in liquid form).

It is possible to obtain a varnish-like (in liquid form) thermosetting resin composition, for example, by introducing each of the components described above into a solvent and dissolving or dispersing each component in the solvent. Specific methods of dissolution/dispersion include an ultrasonic dispersion method, a high-pressure collision type dispersion method, a high-speed rotary dispersion method, a bead mill method, a high-speed shear dispersion method, a rotation-revolution type dispersion method, and the like.

The usable solvents are not particularly limited. The solvent is typically an organic solvent. Specifically, examples thereof include methyl ethyl ketone, methyl isobutyl ketone, propylene glycol monomethyl ether, toluene, ethyl acetate, hexane, cyclohexane, cyclohexanone, tetrahydrofuran, dimethylformamide, dimethylacetamide, dimethyl sulfoxide, ethylene glycol, anisole, cellosolve-based solvents, carbinol-based solvents, N-methylpyrrolidone, and the like. The solvents may be used alone or two or more may be used in combination.

(Resin Sheet)

The resin sheet of the present embodiment is provided with a carrier base material and a resin layer, which is formed of the thermosetting resin composition of the present embodiment, which is provided on the carrier base material.

It is possible to manufacture such a resin sheet, for example, by coating the varnish-like (in liquid form) thermosetting resin composition described above on the carrier base material, or the like.

Specifically, it is possible to obtain the resin sheet of the present embodiment by performing a solvent removal process with respect to the coating film (resin layer) obtained by coating the varnish-like thermosetting resin composition onto the carrier base material.

It is possible for the solvent content in the resin sheet to be 10% by mass or less with respect to the entire thermosetting resin composition.

It is possible to perform the solvent removal process, for example, under conditions of 80° C. to 200° C. for 1 to 30 minutes.

Examples of the carrier base material include a polymer film, a metal foil, and the like.

Polymer films are not particularly limited. Examples thereof include polyolefins such as polyethylene and polypropylene, polyesters such as polyethylene terephthalate and polybutylene terephthalate, polycarbonates, release papers such as silicone sheets, thermoplastic resin sheets having heat resistance such as fluorine-based resins and polyimide resins, and the like.

Metal foils are not particularly limited. Examples thereof include copper and/or copper-based alloys, aluminum and/or aluminum-based alloys, iron and/or iron-based alloys, silver and/or silver-based alloys, gold and gold-based alloys, zinc and zinc-based alloys, nickel and nickel-based alloys, tin and tin-based alloys, and the like.

(Resin Substrate)

The resin substrate of the present embodiment is provided with an insulating layer formed of a cured product of a thermosetting resin composition. It is possible to use this resin substrate as a material for printed substrates for mounting electronic components such as LEDs and power modules.

(Metal Base Substrate)

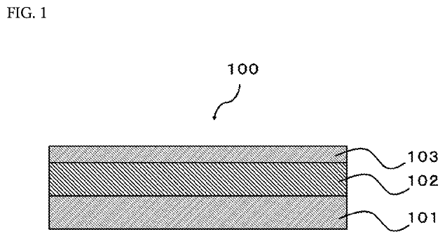

A description will be given of a metal base substrate 100 of the present embodiment based on FIG. 1.

FIG. 1 is a cross-sectional view showing an example of the configuration of the metal base substrate 100.

As shown in FIG. 1, it is possible for the metal base substrate 100 to be provided with a metal substrate 101, an insulating layer 102 provided on the metal substrate 101, and a metal layer 103 provided on the insulating layer 102.

It is possible for the insulating layer 102 to be formed of one type selected from the group consisting of a resin layer formed of a thermosetting resin composition, and a cured product and a laminate of the thermosetting resin composition. Each of these resin layers and laminates may be formed of a thermosetting resin composition in a B-stage state (semi-cured state) before circuit processing of the metal layer 103 and may be a cured body which is cured and processed therefrom after circuit processing.

The metal layer 103 is provided on the insulating layer 102 and is subjected to circuit processing.

Examples of the metal forming the metal layer 103 include one or two or more types of metal selected from copper, copper alloy, aluminum, aluminum alloy, nickel, iron, tin, and the like. Among the above, the metal layer 103 is preferably a copper layer or an aluminum layer, and particularly preferably a copper layer. Using copper or aluminum makes it possible to make the circuit processability of the metal layer 103 good. As the metal layer 103, a metal foil available in plate form may be used or a metal foil available in roll form may be used.

The lower limit value of the thickness of the metal layer 103 is, for example, 0.01 mm or more, and preferably 0.035 mm or more.

The metal layer 103 being moderately thick makes preferable application possible in applications that require a high current.

The upper limit value of the thickness of the metal layer 103 is, for example, 10.0 mm or less, and preferably 0.5 mm or less. Being such a value or less makes it possible to improve the circuit processability and also to make the substrate as a whole thinner.

The metal substrate 101 has the role of dissipating the heat accumulated in the metal base substrate 100.

As long as the metal substrate 101 is a heat-dissipating metal substrate, there is no particular limitation thereon. The metal substrate 101 is, for example, a copper substrate, a copper alloy substrate, an aluminum substrate, or an aluminum alloy substrate, a copper substrate or an aluminum substrate are preferable, and a copper substrate is more preferable. Using a copper substrate or an aluminum substrate makes it possible to make the heat dissipation of the metal substrate 101 good.

It is possible to appropriately set the thickness of the metal substrate 101 as long as the purpose of the present invention is not impaired.

The upper limit value of the thickness of the metal substrate 101 is, for example, 20.0 mm or less, and preferably 5.0 mm or less. A thickness of 20.0 mm or less makes it possible to improve the processability of the metal base substrate 100 in outline processing, cut-out processing, and the like.

In addition, the lower limit value of the thickness of the metal substrate 101 is, for example, 0.01 mm or more, and preferably 0.6 mm or more. Using the metal substrate 101 with a thickness of 0.01 mm or more makes it possible to improve the heat dissipation of the metal base substrate 100 as a whole.

It is possible to use the metal base substrate 100 for various substrate applications. Since the thermal conductivity and heat resistance are excellent, use is possible as a printed substrate using LEDs and power modules.

It is possible for the metal base substrate 100 to have the metal layer 103 which is circuit processed by etching into a pattern, or the like. In the metal base substrate 100, an unshown solder resist may be formed on the outermost layer and the electrode portions for connection may be exposed such that it is possible to mount electronic components thereon by exposure and development.

Although the embodiments of the present invention have been described above, these are examples of the present invention and various configurations other than the above may be adopted. In addition, the present invention is not limited to the embodiments described above and modifications, improvements, and the like are included in the present invention within a scope in which it is possible to achieve the object of the present invention.

### Examples

A detailed description will be given of embodiments of the present invention based on Examples and Comparative Examples. The present invention is not limited to the Examples.

<Manufacturing of Thermosetting Resin Composition (Varnish-Like)>

Each of the components described in Table 1 below was added to methyl ethyl ketone (MEK) and stirred. The amount of MEK was appropriately adjusted in consideration of the film thickness in the subsequent evaluation. Due to this, a varnish-like resin composition (P) was obtained.

The unit for the amount of each component in Table 1 is parts by mass.

The details of each component in Table 1 are as follows.

(Epoxy Resin)
Epoxy 1: Epoxy resin represented by the following structural formula, model number “EPICLON 830”, manufactured by DIC Corporation.

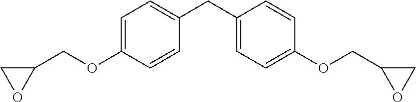 [SMILES: c1cc(OCC2CO2)ccc1Cc1ccc(OCC2CO2)cc1]

Epoxy 2: Epoxy resin represented by the following structural formula, model number “EPICLON HP-4700”, manufactured by DIC Corporation.

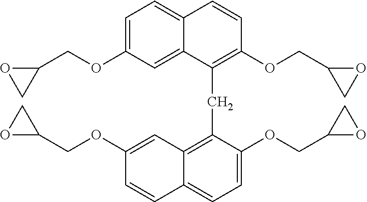 [SMILES: c1cc2ccc(OCC3CO3)c(Cc3c(OCC4CO4)ccc4ccc(OCC5CO5)cc34)c2cc1OCC1CO1]

(Curing agent (which does not produce a hydroxy group by reaction with an epoxy group))
Cyanate 1: Primaset “PT-30”, manufactured by Lonza
Active ester 1: HPC-8000-65T, manufactured by DIC Corporation.

Phenoxy resin (mesogen skeleton-containing resin and the like)
Phenoxy 1: Bisphenol A phenoxy resin represented by the following chemical formula (no mesogenic structure, “jER-4275” manufactured by Mitsubishi Chemical Corporation)

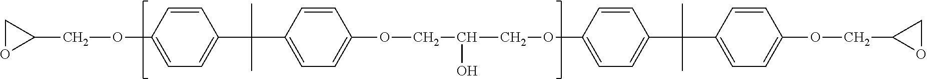

Phenoxy 2: Phenoxy resin obtained by the following synthesis method

23.5 parts by mass of an epoxy resin (mesogenic structure, bifunctional epoxy compound with the following structure, manufactured by Mitsubishi Chemical Corporation, YX4000), 72.5 parts by mass of bisphenol compound (mesogenic structure, bifunctional phenol with the following structure, manufactured by Ueno Pharmaceutical Co., Ltd., HQPOB), 0.04 parts by mass of triphenylphosphine (TPP), and 3.9 parts by mass of solvent (methyl ethyl ketone) were dropped into the reactor. A reaction was then carried out at a temperature of 120° C. to 150° C. while removing the solvent. The reaction was stopped after confirming that the desired molecular weight was achieved by GPC. Due to this, a phenoxy resin (phenoxy 2) with a molecular weight of 4500 was obtained.

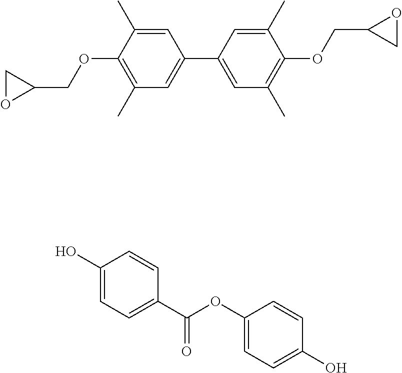 [SMILES: Cc1cc(-c2cc(C)c(OCC3CO3)c(C)c2)cc(C)c1OCC1CO1 ; O=C(Oc1ccc(O)cc1)c1ccc(O)cc1]

Phenoxy 3: Phenoxy resin obtained by the following synthesis procedure

Phenoxy 3 was obtained by the same method as the synthesis method of “Phenoxy 2” described above, except that the epoxy resin was 2,6-dihydroxynaphthalene diglycidyl ether with the following structure and the bisphenol compound was 2,6-dihydroxynaphthalene with the following structure. The weight average molecular weight of the obtained resin was 4800.

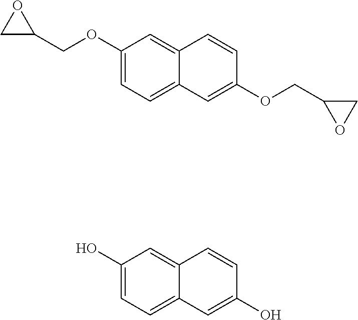 [SMILES: c1cc2cc(OCC3CO3)ccc2cc1OCC1CO1 ; Oc1ccc2cc(O)ccc2c1]

Phenoxy 4: Phenoxy resin obtained by the following synthesis procedure

Phenoxy 4 was obtained by the same method as the synthesis method of “Phenoxy 2” described above, except that the epoxy resin was 4,4′-dihydroxybiphenyl diglycidyl ether with the following structure and the bisphenol compound was HQ-POB with the following structure. The weight average molecular weight of the obtained resin was 6400.

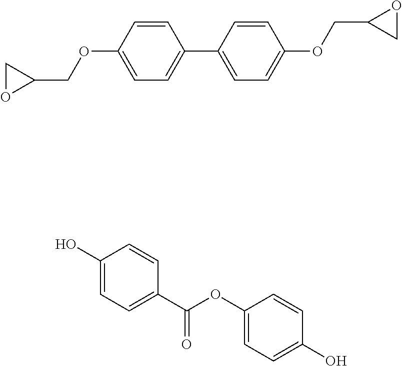 [SMILES: c1cc(-c2ccc(OCC3CO3)cc2)ccc1OCC1CO1 ; O=C(Oc1ccc(O)cc1)c1ccc(O)cc1]

Phenoxy 5: Phenoxy resin obtained by the following synthesis procedure

Phenoxy 5 was obtained by the same method as the synthesis method of “Phenoxy 2” described above, except that the epoxy resin was 4,4′-dihydroxybiphenyl diglycidyl ether with the following structure and the bisphenol compound was 2,7-dihydroxynaphthalene with the following structure. The weight average molecular weight of the obtained resin was 7700.

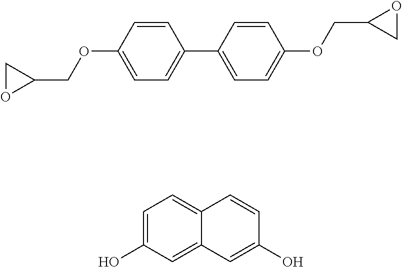 [SMILES: c1cc(-c2ccc(OCC3CO3)cc2)ccc1OCC1CO1 ; Oc1ccc2ccc(O)cc2c1]

Phenoxy 6: Phenoxy resin obtained by the following synthesis procedure

Phenoxy 5 was obtained by the same method as the synthesis method of “Phenoxy 2” described above, except that the epoxy resin was 4,4′-dihydroxybiphenyl diglycidyl ether with the following structure and the bisphenol compound was hydroquinone with the following structure. The weight average molecular weight of the obtained resin was 4600.

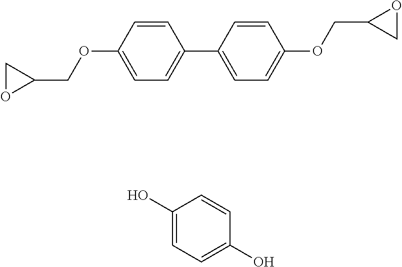 [SMILES: c1cc(-c2ccc(OCC3CO3)cc2)ccc1OCC1CO1 ; Oc1ccc(O)cc1]

(Curing Accelerator)
Novolac 1: Novolac resin “PR-51470” manufactured by Sumitomo Bakelite Co., Ltd.
Imidazole 1: 2-methylimidazole manufactured by Tokyo Chemical Industry Co., Ltd.

(Thermally Conductive Particles)

Granular boron nitride prepared by the following procedure

[Procedure]

Commercially available boron carbide powder was introduced into a carbon crucible and subjected to a nitriding process under conditions of a nitrogen atmosphere at 2000° C. for 10 hours.

Next, commercially available diboron trioxide powder was added to the boron nitride powder subjected to a nitriding process described above and mixed for one hour using a blender (boron nitride: diboron trioxide=7:3 (mass ratio)). The obtained mixture was introduced into a carbon crucible and sintered under conditions of a nitrogen atmosphere at 2000° C. for 10 hours.

Granular boron nitride was obtained as described above.

<Preparation of Samples for Measurement/Evaluation (Cured Products for Measurement)>

A varnish-like resin composition (P) was coated on a PET film and heat-treated at 100° C. for 30 minutes to produce a thermally conductive sheet in B-stage form (a semi-cured state) with a film thickness of 200 μm (0.2 mm). The above was then peeled off from the PET film and heat-treated at 200° C. for 90 minutes to obtain a thermally conductive sheet cured product.

This thermally conductive sheet cured product is also referred to as the “cured product for measurement” below.

<Measurement of Characteristics of Cured Product of Thermosetting Resin Composition>

(Thermal Conductivity at 200° C. λ₂₀₀)

The thermal conductivity is determined by the formula α×Cp×ρ (α is the thermal diffusion coefficient, Cp is the specific heat, and ρ is the density). Thus, α, Cp, and ρ, were measured, respectively, to determine the thermal conductivity. Specifically, the results are as follows.

Measurement of Thermal Diffusion Coefficient α at 200° C.

The cured product for measurement was cut out to a thickness of approximately 0.2 mm and a size of 10 mm×10 mm. This was set in the apparatus “LFA447 NanoFlash” manufactured by NETZSCH and held at 200° C. in air. Then, the thermal diffusion coefficient α at 200° C. was measured by the laser flash method.

Measurement of Specific Heat Cp at 200° C.

The specific heat (Cp) at 200° C. of the cured product for measurement was measured by the DSC method in accordance with JIS K 7123 (specific heat capacity measurement method for plastics).

Measurement of Density ρ

Measurement of the density (φ was performed in accordance with JIS K 6911 (general test method for thermosetting plastics). For the test piece, the cured product for measurement was cut out to 2 cm length×2 cm width×0.2 mm thickness.

The density ρ was measured at 23° C. Strictly speaking, in order to determine λ₂₀₀, it is necessary to determine the density ρ at 200° C.; however, due to the difficulty of measurement and the like, the change in density ρ between 23° C. and 200° C. was ignored.

Calculation of Thermal Conductivity λ₂₀₀ at 200° C.

The thermal conductivity at 200° C., λ₂₀₀, was calculated by multiplying α, Cp, and ρ determined as described above.

Volume Resistivity at 200° C. (R₂₀₀)

The measurement was carried out in accordance with JIS C 2139.

Specifically, the cured product for measurement, which was processed to an appropriate size, was placed in an oven at 200° C. and the volume resistivity was measured upon reaching the desired temperature (that is, 200° C.).

(Linear Expansion Coefficient α₁ of Cured Product at 23° C. to 40° C.)

A test piece for measuring the linear expansion coefficient was produced by processing the cured product for measurement into a size of 4 mm×20 mm. This test piece was set in a thermal mechanical analyzer (TMA) test apparatus (TMA/SS6100 manufactured by Seiko Instruments Inc.). Then, two cycles of thermomechanical analysis (TMA) were measured under conditions of a temperature rising rate of 5° C./min, a load of 0.05 N, tensile mode, and a measurement temperature range of 30° C. to 320° C.

Among the obtained results, the average values of the linear expansion coefficients in the plane direction (XY direction) in the range of 23° C. to 40° C. were determined from the information of the second cycle.

(Glass Transition Temperature Tg of Cured Product)

The obtained varnish-like resin composition (P) was heat-treated at 100° C. for 30 minutes to produce a thermally conductive sheet in B-stage form (a semi-cured state) with a film thickness of 400 μm.

Next, this thermally conductive sheet was heat-treated at 200° C. for 90 minutes to obtain a cured product of a thermally conductive sheet.

The glass transition temperature (Tg) of the obtained cured product was measured by dynamic mechanical analysis (DMA) under conditions of a temperature rising rate of 5° C./min and a frequency of 1 Hz. The peak top temperature of tan δ was used as Tg.

<Evaluation of Heat Dissipation in a High-Temperature Environment Mimicking the Environment of a Generator>

A varnish-like resin composition (P) was coated on a copper foil and heated at 100° C. for 30 minutes to prepare a copper foil with a resin composition in B-stage form (a semi-cured state) attached thereto.

This copper foil was cut out to a size of 100 mm×100 mm and cured while being bonded to a 3 mm thick SUS plate under the pressing conditions of 200° C. and 25 MPa, for 90 minutes.

In the above manner, a substrate for heat dissipation evaluation was produced.

The obtained substrate was placed on a hot plate with the SUS side as the upper surface and preheated such that the surface temperature was 200° C. After confirming that the substrate reached the desired temperature (200° C.), the substrate was quickly moved onto a hot plate heated to 250° C. in advance. At this time, the front and back of the substrate were not changed.

After the substrate was moved, the temperature rise on the surface of the substrate was tracked and the time taken to reach the saturation point (250° C.) was measured.

The time to reach the saturation point was evaluated as A (very good) if the time was less than 250 seconds, B (good) if the time was 250 seconds or more and 300 seconds or less, and C (somewhat poor) if the time was over 300 seconds.

A cured product which takes a short time to reach the saturation point may be said to be a cured product able to successfully allow heat to escape even in an environment with high ambient temperatures, such as at the periphery of a generator.

The compositions, properties, and evaluation results of the thermosetting resin compositions are shown together in Table 1 below.

TABLE 1

| | | | | | | | | | | | | | Com- | Com- | Com- | Com- | Com- |
|---|---|---|---|---|---|---|---|---|---|---|---|---|---|---|---|---|---|
| | | | | | | | | | | | | | para- | para- | para- | para- | para- |
| | | | | | | | | | | | | | tive- | tive- | tive- | tive- | tive- |
| | | | | | | | | | | | | | Exam- | Exam- | Exam- | Exam- | Exam- |
| | | Example 1 | Example 2 | Example 3 | Example 4 | Example 5 | Example 6 | Example 7 | Example 8 | Example 9 | Example 10 | Example 11 | ple 1 | ple 2 | ple 3 | ple 4 | ple 5 |
| Epoxy resin | Epoxy 1 | 15 | 15 | 15 | 15 | 15 | 15 | 15 | 15 | 15 | 15 | 15 | 15 | 15 | 15 | 15 | 15 |
| | Epoxy 2 | 19 | 19 | 19 | 19 | 19 | 19 | 19 | 19 | 19 | 19 | 19 | 59 | 39 | 39 | | 19 |
| Curing agent | Cyanate 1 | | | | | | 40 | 40 | 40 | 40 | 40 | 40 | | 20 | | | |
| (curing agent | | | | | | | | | | | | | | | | | |
| (a) ) | Active ester | 40 | 40 | 40 | 40 | 40 | | | | | | | | | 20 | 59 | 40 |
| | 1 | | | | | | | | | | | | | | | | |
| Phenoxy resin | Phenoxy 1 | 3 | 3 | 3 | 3 | 3 | 3 | 3 | 3 | 3 | 3 | 3 | 3 | 3 | 3 | 3 | 24 |
| (mesogen | Phenoxy 2 | 21 | | | | | 21 | | | | | | 21 | 21 | 21 | 21 | |
| skeleton-contain- | Phenoxy 3 | | 21 | | | | | 21 | | | | | | | | | |
| ing resin or the | Phenoxy 4 | | | 21 | | | | | 21 | | | | | | | | |
| like) | Phenoxy 5 | | | | 21 | | | | | 21 | | | | | | | |
| | Phenoxy 6 | | | | | 21 | | | | | 21 | 21 | | | | | |
| Curing | Novolac 1 | | | | | | | 2 | 2 | 2 | 2 | | | 2 | | | 2 |
| accelerator | Imidazole 1 | 2 | 2 | 2 | 2 | 2 | 2 | | | | | 2 | 2 | | 2 | 2 | |
| Total resin content | | 100 | 100 | 100 | 100 | 100 | 100 | 100 | 100 | 100 | 100 | 100 | 100 | 100 | 100 | 100 | 100 |
| Thermally | Granular | 300 | 300 | 300 | 300 | 300 | 300 | 300 | 290 | 300 | 290 | 300 | 300 | 300 | 300 | 300 | 300 |
| conductive | boron | | | | | | | | | | | | | | | | |
| particles | nitride | | | | | | | | | | | | | | | | |
| Characteristics | Tg (° C.) | 234 | 242 | 235 | 245 | 233 | 260 | 265 | 262 | 263 | 258 | 255 | 231 | 246 | 234 | 272 | 258 |
| | Linear | 14.3 | 13.6 | 13.4 | 13.7 | 14.1 | 9.6 | 9.8 | 10.1 | 9.9 | 10.2 | 10.1 | 14.3 | 11.2 | 13.9 | 9.3 | 9.6 |
| | expansion | | | | | | | | | | | | | | | | |
| | coefficient | | | | | | | | | | | | | | | | |
| | α1 (ppm) | | | | | | | | | | | | | | | | |
| | Thermal | 12.1 | 13.2 | 12.5 | 12.6 | 12.8 | 13.5 | 14.1 | 14.5 | 14.5 | 15.2 | 14.8 | 11.2 | 11.6 | 10.4 | 11.8 | 11.5 |
| | conductivity | | | | | | | | | | | | | | | | |
| | at 200° C. | | | | | | | | | | | | | | | | |
| | (λ200 , | | | | | | | | | | | | | | | | |
| | W/ (m · K)) | | | | | | | | | | | | | | | | |
| | Volume | 45 | 56 | 56 | 48 | 52 | 89 | 88 | 88 | 83 | 78 | 79 | 0.2 | 1.3 | 1 | 100 | 88 |
| | resistivity | | | | | | | | | | | | | | | | |
| | at 200° C. | | | | | | | | | | | | | | | | |
| | (R₂₀₀, × 10¹⁰ | | | | | | | | | | | | | | | | |
| | Ω · m) | | | | | | | | | | | | | | | | |

| | | | | | | | | | | | | | | | | |
|---|---|---|---|---|---|---|---|---|---|---|---|---|---|---|---|---|
| Evaluation of heat | B | B | B | B | A | B | A | A | A | A | A | C | C | C | C | C |
| dissipation in a | | | | | | | | | | | | | | | | |
| high-temperature environment | | | | | | | | | | | | | | | | |

Comparing Examples and the Comparative Examples, the Examples exhibited better “heat dissipation under a high temperature environment”. This may be considered to be due to the larger λ200 in the Examples, and the like.

In addition, the values of R₂₀₀ in Examples 1 to 11 were sufficiently large.

From this, it is clear that, for example, forming the heat-dissipating member in the power module with the cured products of the compositions of Examples 1 to 11 makes it possible to reduce the leakage current and obtain an effect of suppressing leakage of electricity, short circuits, and the like during high temperature operation of the power module.

This application claims priority based on Japanese Application JP 2019-115337 filed on Jun. 21, 2019, the entire disclosure of which is hereby incorporated herein.

### REFERENCE SIGNS LIST

100: metal base substrate
101: metal substrate
102: insulating layer
103: metal layer

What is claim is:

1. A thermosetting resin composition comprising:
an epoxy resin; and
thermally conductive particles,
wherein a thermal conductivity λ200 at 200° C. of a cured product obtained by heating the thermosetting resin composition at 200° C. for 90 minutes is 12 W/(m·K) or higher.

2. The thermosetting resin composition according to claim 1,
wherein a volume resistivity R₂₀₀ of the cured product at 200° C. is 1.0×1010 Ω m or more.

3. The thermosetting resin composition according to claim 1, further comprising
a curing agent,
wherein the curing agent includes a curing agent (a) which does not produce hydroxy groups upon reaction with epoxy groups.

4. The thermosetting resin composition according to claim 3,
wherein the curing agent (a) includes one or two or more selected from the group consisting of a polyarylate compound, an active ester compound, a cyanate ester compound, an isocyanate compound, and an imidazole compound.

5. The thermosetting resin composition according to claim 1,
wherein the epoxy resin includes a mesogen skeleton.

6. The thermosetting resin composition according to claim 1,
wherein a part or all of the epoxy resin is in liquid form at 23° C.

7. The thermosetting resin composition according to claim 3,
wherein an equivalent ratio of the curing agent (a) with respect to the epoxy resin in the thermosetting resin composition is 1.0 to 2.0.

8. The thermosetting resin composition according to claim 1, further comprising
a curing accelerator.

9. The thermosetting resin composition according to claim 1, further comprising
a resin having a mesogenic structure and a weight average molecular weight of 500 or more, in addition to the epoxy resin.

10. The thermosetting resin composition according to claim 1,
wherein the thermally conductive particles include one or more selected from the group consisting of silica, alumina, aluminum nitride, boron nitride, silicon nitride, silicon carbide, and magnesium oxide.

11. The thermosetting resin composition according to claim 1,
wherein a linear expansion coefficient α1 of the cured product at 23° C. to 40° C. is 20 ppm/° C. or lower.

12. The thermosetting resin composition according to claim 1,
wherein a glass transition temperature of the cured product is 180° C. or higher.

13. A resin sheet comprising:
a carrier base material; and
a resin layer, which is formed of the thermosetting resin composition according to claim 1, provided on the carrier base material.

14. A metal base substrate comprising:
a metal substrate;
an insulating layer provided on the metal substrate; and
a metal layer provided on the insulating layer,
wherein the insulating layer is formed of a resin layer formed of the thermosetting resin composition according to claim 1, or a cured product of the thermosetting resin composition according to claim 1.
